(19) United States
(12) Patent Application Publication
(10) Pub. No.: US 2020/0086277 A1
(43) Pub. Date: Mar. 19, 2020

(54) METHOD FOR PREPARING MICROSTRUCTURE ARRAYS ON THE SURFACE OF THIN FILM MATERIAL

(71) Applicant: King Abdullah University of Science and Technology, Thuwal (SA)

(72) Inventors: Peng WANG, Thuwal (SA); Bo TANG, Thuwal (SA); Li-anbin ZHANG, Thuwal (SA)

(21) Appl. No.: 15/750,742

(22) PCT Filed: Aug. 5, 2016
(86) PCT No.: PCT/IB2016/054750

§ 371 Date: Feb. 6, 2018

(51) Int. Cl. B01D 67/00; B01D 69/10; B01D 69/02; B01D 71/02; C01B 32/198; C01B 32/194

(52) U.S. Cl. CPC B01D 67/0004; B01D 69/10; B01D 69/02; B01D 71/021; C01B 2204/04; C01B 32/198; C01B 32/194; B01D 2325/02; B01D 2325/04; B01D 71/024

(57) ABSTRACT

Methods are provided for growing a thin film of a nanoscale material. Thin films of nanoscale materials are also provided. The films can be grown with microscale patterning. The method can include vacuum filtration of a solution containing the nanostructured material through a porous substrate. The porous substrate can have a pore size that is comparable to the size of the nanoscale material. By patterning the pores on the surface of the substrate, a film can be grown having the pattern on a surface of the thin film, including on the top surface opposite the substrate. The nanoscale material can be graphene, graphene oxide, reduced graphene oxide, molybdenum disulfide, hexagonal membrane boron nitride, tungsten diselenide, molybdenum trioxide, or clays such as montmorillonite or lapnotie. The porous strate can be a porous organic or inorganic membrane, a silicon stencil membrane, or similar membrane having pore sizes on the order of microns.

### CROSS-REFERENCE TO RELATED APPLICATIONS

This application claims priority to, and the benefit of, co-pending U.S. provisional application entitled “METHOD FOR PREPARING MICROSTRUCTURE ARRAYS ON THE SURFACE OF THIN FILM MATERIAL” having Ser. No. 62/201,710, filed Aug. 6, 2015, the contents of which are incorporated by reference in their entirety.

### TECHNICAL FIELD

The present disclosure generally relates to thin film materials and methods of making thereof.

### BACKGROUND

Graphene, an atom-thin layer of pure carbon, due to its exceptional properties, promises many unprecedented applications.^{1.2} However, the unpleasant reality is that many of the current methods of producing graphene do not provide a reasonable yield.³ So far, synthesis of graphene oxide (GO) sheet has been largely performed by chemical exfoliation of graphite³⁻⁶, followed by reduction of the GO to reduced GO (rGO) and it is the rGO that is widely used as the substitute to graphene in most of the exploratory research as rGO and graphene have shown similar physical and chemical properties⁷⁻¹³.

One added benefit of the GO to rGO method is that, GO, due to its charges, can be well dispersed in aqueous media, which facilitates many of solution based graphene processing¹⁴. Vacuum filtration, a conventional and simple laboratory technique of separating solids from fluids, has recently found its way into the emerging graphene field and established itself as an excellent method of making free-standing GO and rGO membranes¹⁵⁻²⁹. In the vacuum filtration, GO solution is filtered through a membrane substrate under vacuum, and GO sheets, due to their big lateral size compared with the size of membrane pore, are retained and thus stack up on the membrane surface, forming a GO membrane. After proper chemical reduction, the GO membrane can then be converted into rGO membrane^{11,12,27}. Due to its simplicity, low-cost, and easiness to scale up, the vacuum filtration based graphene membrane fabrication has seen many applications in recent years, such as water desalination and pu ification^{8,17,23-25,28,29}, energy storage^{21,22,26}, and oil-water separation²⁸.

Accordingly, there is a need to address the deficiencies in thin films, and to develop methods of making thin films of graphene oxide and other nanoscale materials with microstructures on the film surfaces

### SUMMARY

A solution to creating microarrays on thin film material surfaces is provided, It is demonstrate that filtration-based membrane preparation has potential to impact the produced rGO membrane property. A vacuum filtrated GO or rGO membrane has two surfaces, which are formed at different interfaces. Taking GO as an example, at the filter membrane and GO sheet interface, one GO surface, referred to as bottom surface hereinafter, is generated immediately upon direct contact between the GO sheets and the filter membrane substrate. The other surface, referred to as top surface hereinafter, is formed at a later stage upon the completion of the vacuum filtration and is at relatively free GO sheets and air interface. The top and the bottom surfaces of the resulting GO or rGO membranes can have different chemical and physical properties, namely the resulting GO or rGO membranes can be asymmetric. The membrane filter substrate leaves its physical imprint on the bottom surface of the rGO membranes. In an aspect, our method is a one-step procedure to obtain microstructure with pattern/array during the preparation of the thin film. It overcomes the limitations presented by use of a multiple process such as lithography. An advantage of our method is that the whole process does not include extra chemical additives. Such technique can be applied but not limited to bioengineering, energy storage, system engineering, scaffold tissue engineering, sensors, membrane based gas/liquid separation industry and so on.

In an embodiment, we provide a one-step method for producing microstructure arrays on surfaces by using porous substrates as the mold. The mold can be, but is not limited to porous organic/ inorganic membranes, silicon stencil membrane, and other substrates with desired pores in micron size. By applying a suspension of materials in a suitable solvent to the porous substrates, upon the removal of the solvents, a duplicate of the microstructures array of the porous substrates can be obtained on the materials surface. The materials can be nanoscale materials including graphene, graphene oxide, reduced graphene oxide, molybdenum disulfide (MoS₂), hexagonal boron nitride (hBN), tungsten diselenide (WSe₂), molybdenum trioxide, clays (MTM, lapnotie) and so on. Preferably, the suspended material has a compatible size match to the pores on the substrate in order to successfully duplicate the microstructure of the substrate. After the solvent completely evaporates, the microstructure arrays can be successfully duplicated on the bottom surface of the thin film. The desired microstructure arrays can be obtained by simply controlling the pattern of the pores on substrate. During the fabrication process, pressure can be applied to accelerate the process.

In various aspects, the present disclosure provides a method of growing a thin film of a nanoscale material. In any one or ore embodiments the method includes vacuum filtration of a solution comprising the nanostructured material and a suitable solvent through a porous substrate to form the thin film on a surface of the substrate. In some embodiments the porous substrate has a pore size that is comparable to the size of the nanoscale material.

In any one or more embodiments the porous substrate has a plurality of pores forming a pattern on the surface of the substrate and the thin films are formed having the pattern on a surface of the thin film, including on the top surface opposite the substrate. In some embodiments the pattern has microscale feature dimensions.

In any one or more embodiments the nanoscale material is graphene, graphene oxide, reduced graphene oxide, molybdenum disulfide (MoS₂), hexagonal boron nitride (hBN), tungsten diselenide (WSe₂), molybdenum trioxide, or a clay such as montmorillonite or lapnotie.

In any one or more embodiments the porous substrate is a porous organic membrane, a porous inorganic membrane, a silicon stencil membrane, or other membranes having a pore size on the order of microns.

In any one or more embodiments the method includes chemical reduction of the nanoscale material forming the thin film. In some embodiments the chemical reduction includes exposing the thin film to a vapor containing a reducing agent such as hydriodic acid, hydrobromic acid, hydrochloric acid, hydrofluoric acid, or a combination thereof. In some embodiments the nanoscale material is graphene oxide and the chemical reduction reduces the graphene oxide to reduced graphene oxide.

In any one or more embodiments the nanoscale material has a largest dimension of 10 nm-100 μm in lateral dimension, In some embodiments the porous substrate has a pore size of 10 nm-100 μm.

In any one or more embodiments the film has a thickness of 10 nm-1 mm, The methods can be used to make thin films with properties that differ from one surface to the opposing surface. For example, in some embodiments the top surface of the thin film has a wettability that is 2-40 times the wettability of the bottom surface of the thin film measured under the same conditions. The wettability can be measured by a water contact angle such as an advancing contact angle, a static contact angle, or a receding contact angle.

Other systems, methods, features, and advantages of the present disclosure method of growing a thin film of a nanoscale material, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views,

FIGS. 1A-1E depict graphene oxide (GO) and reduced graphene oxide (rGO) membrane fabrication and characterization. FIG. 1A shows the setup for the vacuum filtration of the GO. FIG. 1B is an image of the GO membrane (left) and rGO membrane (right) on top of the polyvinylidene fluoride (PVDF) membrane filter with a stated pore size of 0.22 um. FIG. IC is a graph of the relationship between the mass of GO in the starting suspension and the thickness of the rGO membrane. The inset shows a cross-sectional SEM image of rGO membrane prepared from 10 mg GO. FIG. 1D is the FTIR spectrum of the GO (lowerblack curve) and rGO membrane (upper red curve); FIG. 1E is the Raman spectrum of the GO (upper black curve) and rGO (lower red curve) membrane,

FIGS. 2A-2D demonstrate the asymmetric dynamic wettability between two surfaces of reduced graphene oxide (rGO) membrane prepared from polyvinylidene fluoride (PVDF) membrane filter. FIG. 2A depicts the advancing (left) and receding (right) angle of the top surface of the rGO membrane. FIG. 2B depicts the advancing (left) and receding (right) angle of the bottom surface of the rGO membrane. FIG. 2C is a graph of the contact angle (degrees) as a function of film thickness (μm) for the dynamic and static wettability comparison of the top surface of the rGO membrane. FIG. 2D is a graph of the contact angle (degrees) as a function of film thickness (μm) for the dynamic and static wettability comparison of the bottom surface of the rGO membrane, In FIGS. 2C-2D the symbols, from top to bottom, are advancing contact angle (circles), static contact angles (squares), and receding contact angle (diamonds).

FIGS. 3A-3D demonstrate the Ci s X-Ray photoelectron spectroscopy (XPS) spectra and CIO ratio analysis of graphene oxide (GO) and reduced graphene oxide (rGO) membrane. FIG. 3A is a graph of the XPS spectra of the GO membrane. FIG. 3B is a graph of the XPS spectra of the top surface of the rGO membrane. FIG. 3C is a graph of the XPS spectra of the bottom surface of the rGO membrane. FIG. 3D is a graph of the XPS spectra of the partially reduced (10 min hydriodic acid (HI) treatment) top surface of the rGO membrane. The atomic ratios of CIO of these samples are 3.06, 13.2, 8.9, and 3.76, respectively.

FIGS. 4A-4F are scanning electron microscope (SEM) images of reduced graphene oxide (rGO) and polyvinylidene fluoride (PVDF) membrane filter. FIGS. 4A and 4B are, respectively, the top and tilt view SEM images of the top surface of the rGO membrane. FIGS. 4C and 4D are, respectively, the top and tilt view SEM images of the bottom surface of the rGO membrane. FIG. 4E is a SEM image of the original PVDF membrane with a stated pore size of 0.22 um; FIG. 4F is a SEM image of the PVDF membrane after delamination of the rGO membrane.

FIG. 5A is a graph of the XPS spectra of the bottom surfaces of the rGO membrane obtained by PC membrane with a pore size of 0.2 μm. FIG. 5B is a graph of the XPS spectra of the bottom surfaces of the rGO membrane obtained by PC membrane with a pore size of 3 μm.

FIGS. 6A-6B are schematic Illustrations of graphene oxide (GO) stacking mechanism on different pore sized polycarbonate (PC) membrane: (FIG. 6A) 0.2 μm (FIG. 6B) 3.0 μm.

FIGS. 7A-7D demonstrate the preparation of patterned microstructure arrays on reduced graphene oxide (rGO) membranes. FIG. 7A is a scanning electron microscope (SEM) image of the Si wafer with patterned micropore array. FIG. 7B is a SEM image of the bottom surface of rGO membrane produced by the Si wafer in FIG. 7A. FIG. 7C is a SEM image of the tilted surface of rGO membrane produced by the Si wafer in FIG. 7A. FIG. 7D is a cross-sectional view of microstructures on the bottom surface of the rGO membrane produced by the Si wafer in FIG. 7A.

FIGS. 8A-8B are C1s X-ray photoelectron spectroscopy (XPS) spectra and CIO ratio of reduced graphene oxide (rGO) membrane with 4 hour hydriodic acid (HI) vapor treatment, FIG. 8A is a graph of the XPS spectra of the top surface of the rGO membrane reduced by 4 hour HI vapor treatment. FIG. 8B is a graph of the XPS spectra of the bottom surface of the rGO membrane reduced by 4 hour HI vapor treatment. The atomic ratio of C/O between top and bottom surfaces is 13,3 and 9.0, respectively.

FIGS. 9A-9C demonstrate water wettability on the top surface of the partially reduced graphene oxide (GO) membrane by 10 minutes hydriodic acid (HI) treatment. FIG. 9A depicts a static water contact angle of (79°), FIG. 9B depicts an advancing water contact angle (92°). FIG. 9C depicts a receding water contact angle (42°).

FIGS. 10A-10B depict C1s X-ray photoelectron spectroscopy (XPS) spectra of reduced graphene oxide (rGO) membrane prepared on silicon wafer. FIG. 10A is an XPS spectra of the top surface of the rGO membrane prepared on the silicon wafer. FIG. 10B is an XPS spectra of the bottom surface of the rGO membrane prepared on the silicon wafer. The atomic ratios of C/O of the top and bottom surfaces are 7.4 and 6.8 respectively.

FIG. 11 is a scanning electron microscope (SEM) image of the original nylon membrane filter (with a stated pore size -0.45 μm). The actual surface pore size ranges from 0.5 to 4.0 μm.

### DETAILED DESCRIPTION

Described below are various embodiments of the present systems and methods for preparing microstructure arrays on the surface of thin film material. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure, Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e,g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term ‘about” can include traditional rounding according to significant figure of the numerical value. In addition, the phrase “about ‘x’ to ‘y” includes “about ‘x’ to about ‘y’”.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Description

The present disclosure is directed to thin films of nanoscale materials and methods of making thereof, Methods of growing a thin film of a nanoscale material are provided. The methods can include applying a suspension containing the nanostructured material and a suitable solvent onto a porous substrate to form the thin film on a surface of the substrate. In some embodiments, the pressure difference can be applied by vacuum filtration to accelerate the process. The methods can include vacuum filtration of a suspension containing the nanostructured material and a suitable solvent through a porous substrate to form the thin film on a surface of the substrate. In some embodiments the porous substrate has a pore size that is comparable to the size of the nanoscale material. The methods can be used to grow films having a variety of thicknesses. In some embodiments the films have a thickness of about 0.01 μm to 100 μm, 0.01 μm to 50 μm, 0.01 μm to 20 μm, 0.01 μm to 5 pm, 0.05 μm to 20 μm, 1 μm to 20 μm, 1 μm to 10 μm, or 1 μm to 5 μm. In some embodiments the films have a thickness of about 10 nm tot mm, 100 nm, 100 nm to 1 mm, 100 nm to 900 μm, 1 μm to 900 μm, or about 10 μm to 900 μm.

The methods can include vacuum filtration. The vacuum filtration can be performed at a variety of pressures. For example, the pressure can be about 500 Torr, 400 Torr, 300 Torr, 200 Torr, 100 Torr, 50 Torr, 25 Torr, 10 Torr, 5 Torr, 1 Torr, 500 mTorr, 100 mTorr, 50 mTorr, or less.

The methods can be used to form microscale patterns on a surface of the thin film. When a film is grown on a substrate, the film will have at least two surfaces on the macroscale, a “bottom surface” at the interface between the thin film and the substrate and a “top surface” that is opposite the bottom surface or is at the interface between the thin film and the solution/environment when the thin film is on the substrate. The methods can include forming the pattern on the bottom surface, the top surface, or both surfaces of the thin film. In some embodiments the pores on the substrate form a pattern on the surface of the substrate and the pattern, the pattern being formed in the surface of the thin film The pattern can have microscale features or dimensions, meaning that the shapes, patterns, or features formed by the pores in the pattern have a characteristic dimension that is about 50 nm to 50 μm, 1 μm to 50 μm, 2 μm to 50 μm, 2 μm to 40 μm, 4 μm to 40 μm, 4 μm to 30 μm, 4 μm to 20 μm, or 4 μm to 10 μm,

A variety of nanoscale materials can be used to form thin films using the methods provided. The nanoscale material can be graphene, graphene oxide, reduced graphene oxide, molybdenum disulfide (MoS₂), hexagonal boron nitride (hBN), tungsten diselenide (WSe₂), molybdenum trioxide, clays such as montmorillonite or lapnotie, or combinations thereof. The nanoscale material can have a largest dimension of about 10 nm to 100 μm, 10 nm to 10 μm, 10 nm to 1 pm, 100 nm to 1 μm, 200 nm to 1 μm, 1 μm to 100 μm, 1 μm to 50 μm, or 1 μm to 10 μm. The methods can include chemical reduction of the nanoscale material forming the thin film. For example, the nanoscale material can be graphene oxide that can be chemically reduced to reduced graphene oxide. The chemical reduction can include exposing the thin film to a vapor containing a reducing agent such as hydriodic acid, hydrobromic acid, hydrochloric acid, hydrofluoric acid, or a combination thereof.

The methods can include vacuum filtration using a variety of porous substrates known in the art. The porous substrate can be a porous organic membrane, a porous inorganic membrane, a silicon stencil membrane, and other membranes having a pore size on the order of microns. The porous substrate can be a porous PVDF or Si membrane. The porous substrate can have pore sizes of about 0.01 μm to 100 μm, 0.01 μm to 50 μm, 0.1 μm to 25 μm, 0.5 μm to 25 μm, 1 μm to 25 μm, 1 μm to 20 μm, 1 μm to 10 μm, or about 5 μm,

The methods can be used to pattern the surfaces of the thin film, including the top surface and/or the bottom surface. The methods can be used to make thin films having properties that differ from one surface to the opposing surface. For example, the top surface can have a property that is different from the otherwise same property measured under the otherwise same conditions except for on the bottom surface. For example, the wettability of the two surfaces can be opposite, which can be evaluated by a water contact angle such as an advancing contact angle, a static contact angle, or a receding contact angle.

Thin films of nanoscale materials made by the methods described and having the properties described herein are also provided. The thin films can be used in a variety of applications. The thin films can be used, for example, in bioengineering, energy storage, system engineering, scaffold tissue engineering, sensors, membrane based gas/liquid separation applications, as well as others.

### EXAMPLES

A vacuum filtrated GO or rGO membrane has two surfaces, which are formed at different interfaces. Taking GO as an example, at the filter membrane and GO sheet interface, one GO surface, referred to as bottom surface hereinafter, is generated immediately upon direct contact between the GO sheets and the filter membrane substrate. The other surface, referred to as top surface hereinafter, is formed at a later stage upon the completion of the vacuum filtration and is at relatively free GO sheets and air interface. In various aspects, the examples demonstrate that the top and the bottom surfaces of the resulted GO or rGO membranes can have different chemical and physical properties. In various aspects, the examples demonstrate that the resulted GO or rGO membranes can be asymmetric. In various aspects, the examples demonstrate that the membrane filter substrate can leave its physical imprint on the bottom surface of the rGO membranes.

Carefully designed experiments (1) disclose that vacuum filtrated rGO membranes indeed possess asymmetry and the filtration membrane does leave their physical imprint on the bottom surface of the resulted rGO membranes; (2) that it is the filter membrane's physical imprint on the bottom surface of the rGO membranes that gives rise to the asymmetric properties of the rGO membranes; and (3) discover that it is the actual surface pore size of the filter membrane that controls its imprinting during the filtration, with the filter membrane imprinting taking place only when the filter surface pores have similar dimension to GO sheets.

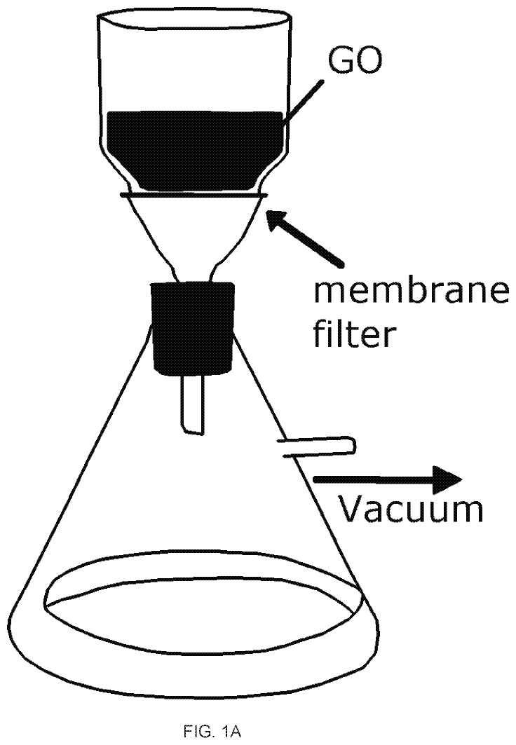

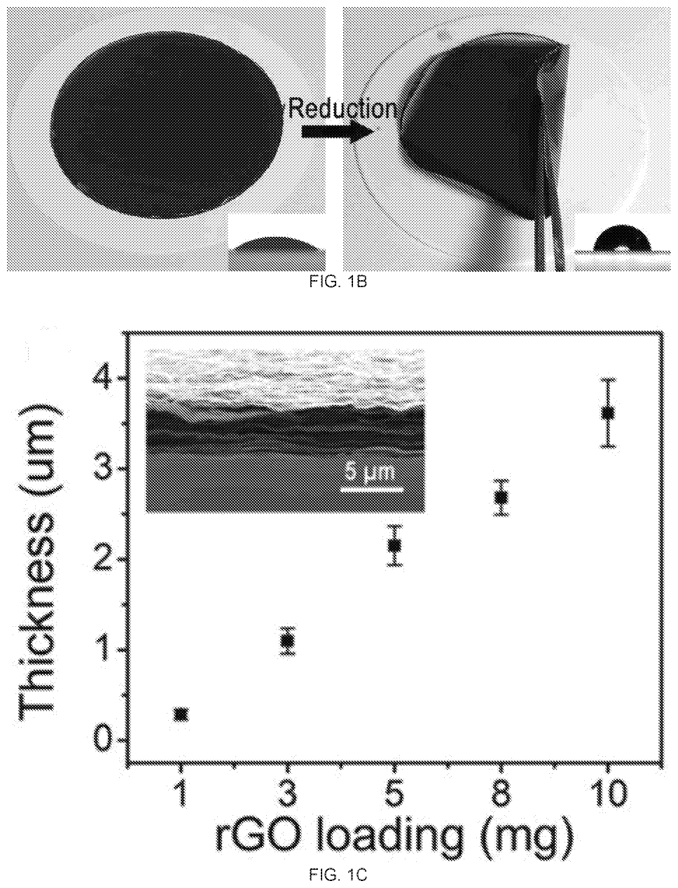

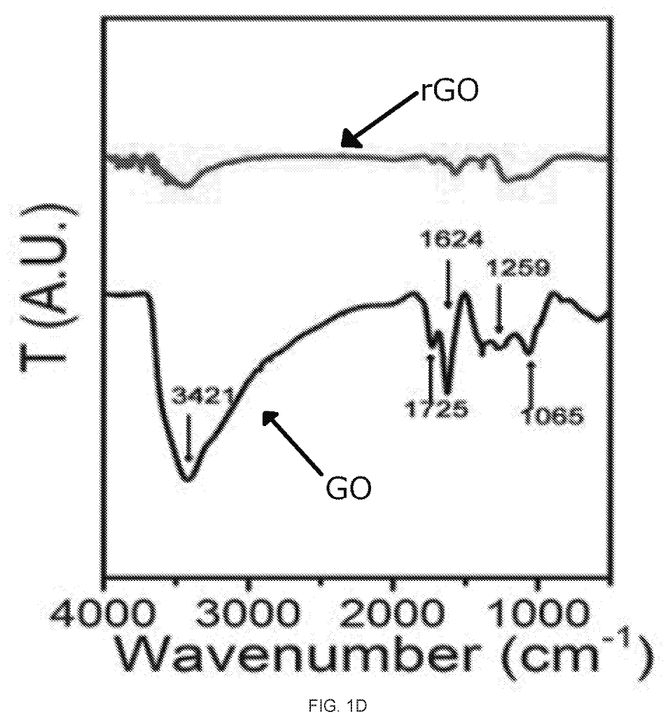

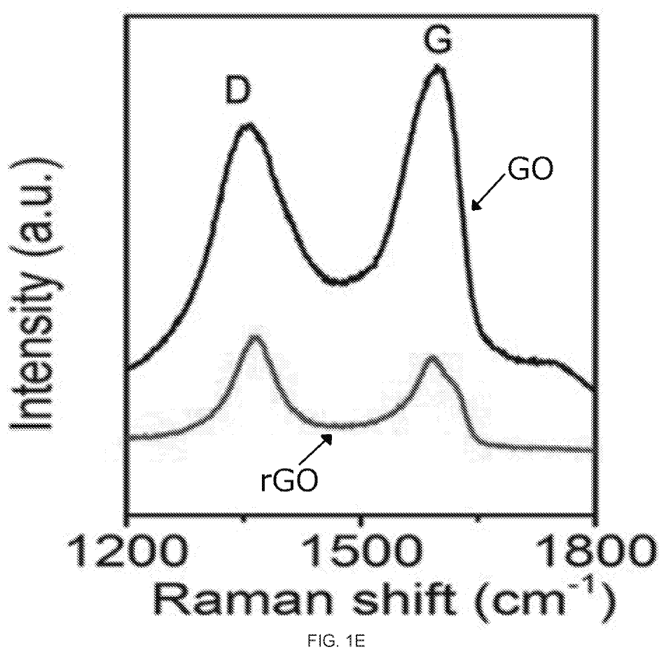

A typical experimental procedure of making rGO membranes by a vacuum filtration is schematically presented in FIG. 1A. In more details, a commercial hydrophilic polyvinylidene fluoride (PVDF) filter membrane with a stated pore size of 0.22 μm, a commonly used filter, was emplayed as filtration media in the vacuum filtration of GO suspension with a known GO mass (e.g., 10 mg) under a pressure difference of 730 mmHg. The GO suspension was undisturbed during the filtration. Upon the completion of the filtration, a dark brown GO membrane was formed (FIG. 1B, left), The GO membrane along with the supporting PVDF filter membrane was air dried before being transferred to a sealed chamber where GO was reduced to rGO membrane by a hydriodic acid (HI) vapor for 2 hour. Upon reduction, the coloration of the membrane changed from dark brown before the reduction to a metallic grey of the resulted rGO membrane (FIG. 1B, right). A free-standing rGO membrane was readily obtained by peeling it off from the filter membrane. The thickness of the resulted rGO membrane was determined by the cross-sectional scanning electronic microscopy (SEM) images of the membranes.

As plotted in FIG. 1C, the thickness of the rGO membranes increased linearly with the mass of the GO in the starting suspensions. The successful reduction of the GO to rGO was confirmed by the Fourier transform infrared (FTIR) and Raman spectroscopy measurements. After the HI treatment, the FTIR spectrum FIG. 1D shows the significantly weakened or disappearance of oxygen containing functional group peaks, such as hydroxyl group at 3421 cm⁻¹, epoxy group at 1259 cm⁻¹, alkoxy group at 1065 cm⁻¹, carboxyl group at 1624 cm⁻¹ and carbonyl group at 1725 cm^{-1 31,32}. In the Raman spectrum, the GO membrane showed two prominent peaks at 1589 and 1365 cm⁻¹ (FIG. 1E), corresponding to the well-documented G and D bands^{11,33}. After the HI treatment, the G and D bands were still present, but the intensity ratio of the D and G bands, I_{D}/I_{G}, increased dramatically, which was attributable to the increased number of isolated sp2 domain after reduction. Moreover, consistent to the prior literature reports, the two surfaces (top and bottom) of the same GO or rGO membranes exhibited almost the same static water contact angles, with the two surfaces of the GO membranes having static water contact angles at −34±2° while those of the rGO ones at −76 5° (insets of FIG. 1B)^{17,34}. These results further confirm the successful reduction of the GO to rGO, as the chemical reduction reduces the polar functional groups of GO. It also seamed to suggest that two surfaces (i.e., top and bottom surfaces) of the GO and rGO are symmetric.

However, some seemingly contradictory but interesting results were later observed. In one experiment, one of our rGO membranes was soaked in water. As soon as the membrane was pulled out of the water vertically, a drastic difference was observed in water behaviors on the two surfaces of the same rGO membrane. On the top surface, a dry surface with no water residue at all was obtained. In sharp contrast, on the bottom surface of the same rGO membrane, there was a thin layer of water film, which adhered to the entire surface firmly. As a matter of fact, these seemingly contradictory wettability results do not contradict each other as they belong to two different domains: the static wettability versus dynamic wettability. The observed different wetting behaviors on the rGO membrane surfaces in the experiment while pulling the membrane out of the water, fall into a dynamic wettability domain, which involves de-wetting of water from the membrane surfaces. The rGO membrane exhibited asymmetrically dynamic wetting behaviors on its two surfaces.

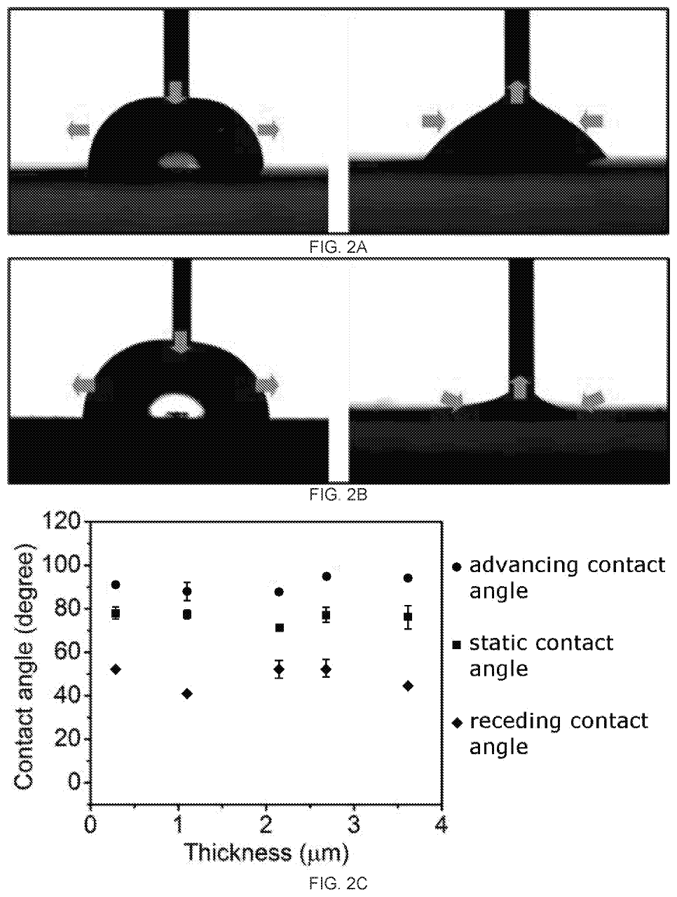

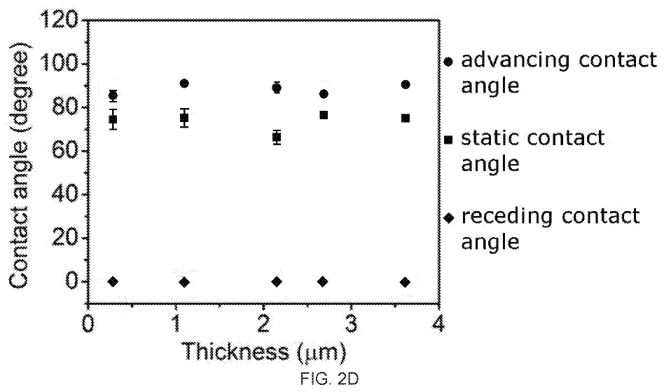

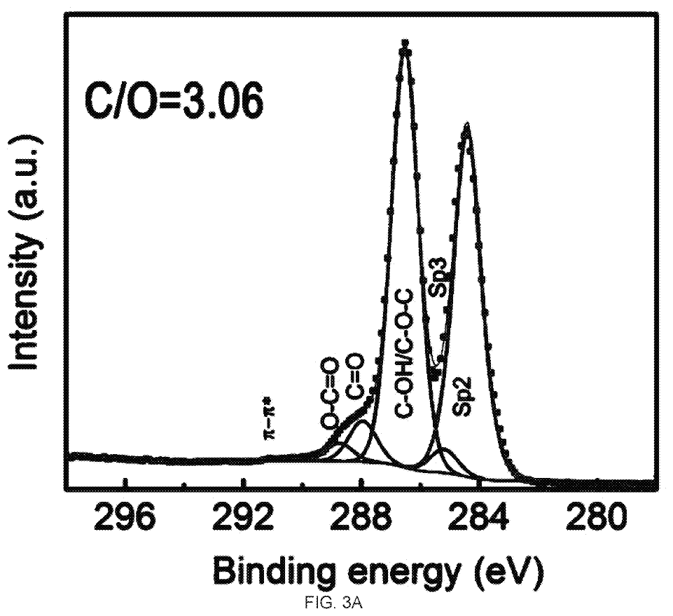

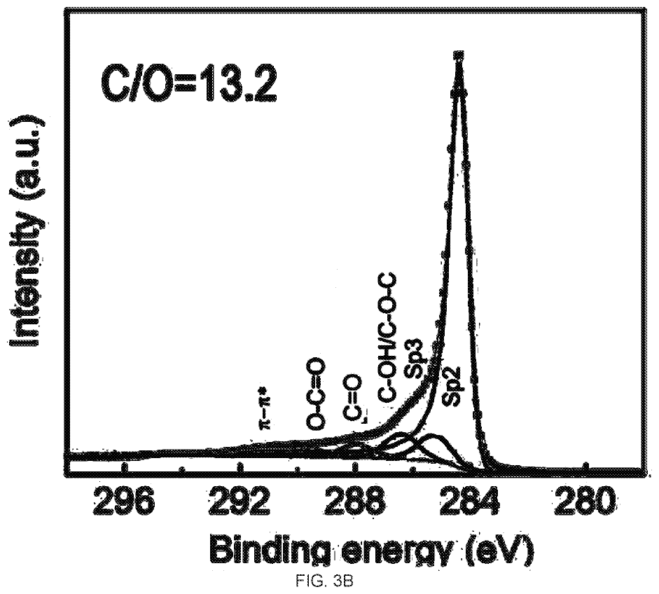

In the dynamic wetting field, researchers rely on advancing contact angle and receding contact angle measurements to provide important information³⁵⁻³⁸. Thus, for the present rGO membranes produced on the PVDF membrane filters, their advancing and receding angles were carefully measured. The results showed: (1) there was no significant difference between the advancing angles of the two surfaces of the same rGO membrane (FIGS. 2A-2B); and (2) nevertheless, a drastic difference was observed on the receding angles between the two surfaces of the same rGO membrane, with the receding angle of the bottom surface measured to be 0° while that of the top surface at −50° (FIGS. 2A-2B). The receding angle of 0° at the bottom surface is an interesting case, indicating the surface's capability to firmly hold the water and its unwillingness to let go of the water. This explains why there was a thin water film at the bottom surface of the rGO membrane after it was taken out of water. On the other hand, the 50° receding angle at the top surface indicates its general inclination to let go of the water. The drastically different water dynamic wetting behavior was consistently observed on the two surfaces of the free standing rGO membranes with thickness 250 nm, as shown in FIG. 2C and FIG. 2D. To facilitate discussion, from this point on, the rGO membrane samples with a thickness of 3.5 μm are used for focused discussions unless otherwise noted.

To find the cause of the asymmetric wetting behavior of the rGO membrane, the surface chemical composition and the surface structure on both the top and bottom surface of the membrane were then analyzed, which are believed to govern the wetting behaviors of solid surface³⁹⁻⁴¹. Both factors were thoroughly investigated in this study. First, X-ray photoelectron spectroscopy (XPS) measurement was conducted to examine the surface chemistry composition of the rGO membrane. It is believed that the magnitude of residual polar groups (e.g., C—O, C═O) on the rGO membrane partially affects its receding angle, with higher content of polar residue leading to smaller receding angle.

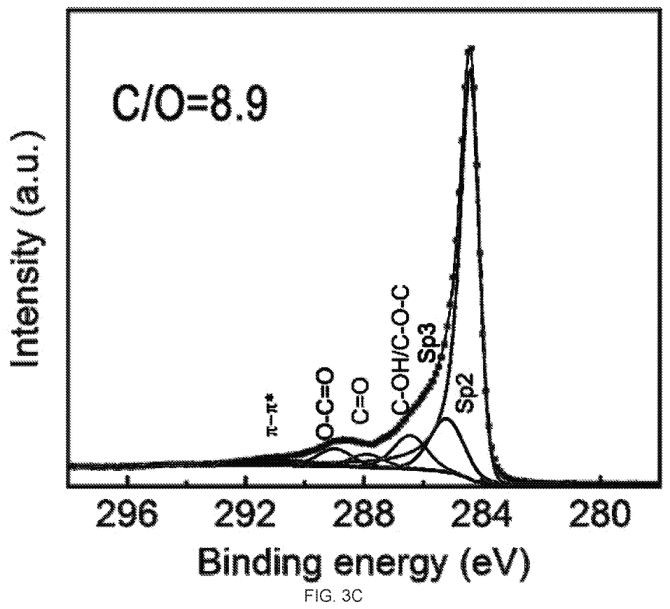

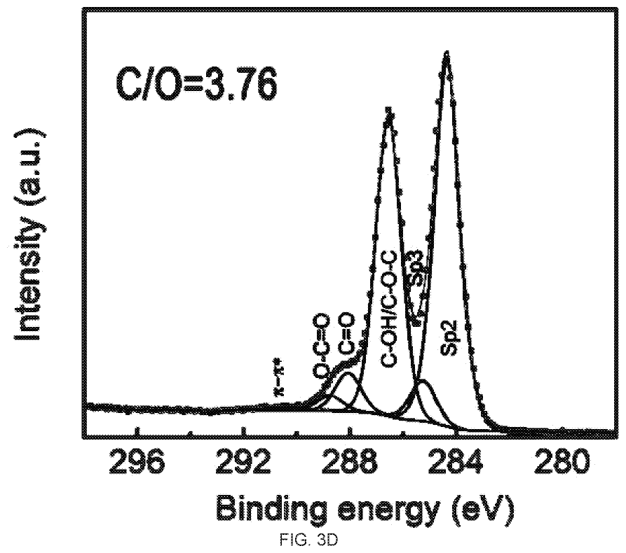

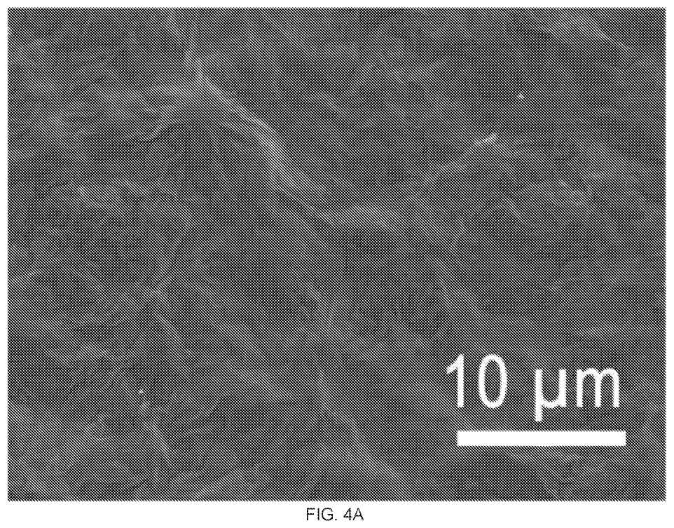

FIGS. 3A-3D show the XPS spectra of the GO (FIG. 3A) and both surfaces (top and bottom) of the rGO membrane after 2 hour HI treatment (FIG. 3B-3C). Before reduction, the C 1s spectrum of the GO (FIG. 3A) was fitted with six components, located at 284.4, 285.1 eV, 286.4, 287.9, 288.9 eV, and 290.6 eV corresponding to the C═C (sp2 hybridized carbon), C—C (sp3 hybridized carbon), C—O—C/C—OH (epoxy and hydroxyl), C═O (carbonyl), O═C—OH (carboxyl) groups and π-π*shake-up satellite structure characteristic of conjugated systems, respectively^{27,32,42,43}. Meanwhile, the dominant peak at 286.4 eV indicates that the most oxygen-containing functional groups in the GO were hydroxyl and epoxy groups. After HI treatment, there was an increase in both the intensity of sp2 hybridized carbon and the intensity of π-π*shake-up satellite structure, in addition to the decrease of the intensity of hydroxyl and epoxy groups on both surfaces of the rGO membrane, demonstrating successful reduction.

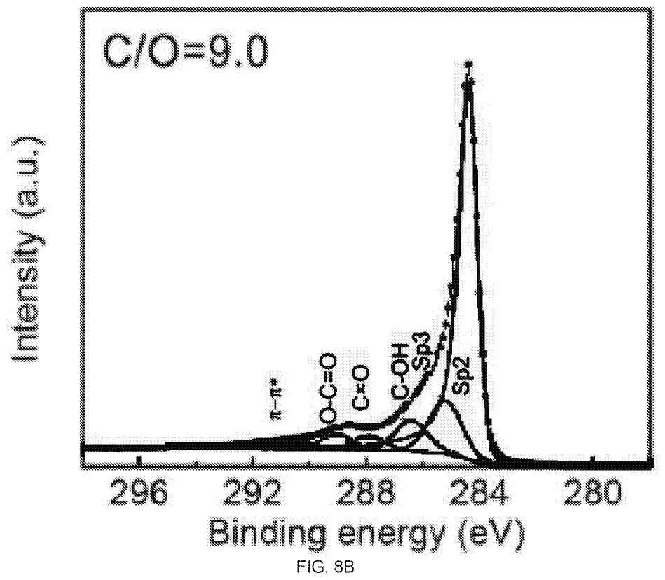

The atomic ratio of C/O was estimated from the survey spectra for these samples. The dramatic increase of the C/O ratio for both surfaces of rGO membrane confirms the efficient removal of oxygen-containing functionalities by the HI reduction. The treatment by HI beyond 2 hours of the rGO membrane showed negligible change in the XPS spectra and the CIO ratio, indicating the sufficient reduction by 2 hour HI treatment (FIGS. 8A-8B). However, the XPS spectra revealed some difference in the residual polar group contents on the two surfaces of the rGO membrane, with the bottom surface having higher polar residual content than that of the top surface (FIG. 3B-3C). While 2 hours was determined to be sufficient time to fully reduce the GO to rGO in this study, in one experiment, we kept the GO membrane in the HI vapor for only 10 minutes to purposefully prepare a partially reduced rGO membrane with a higher polar residual content than the fully reduced rGO membrane by 2 hour HI reduction (FIG. 3D).

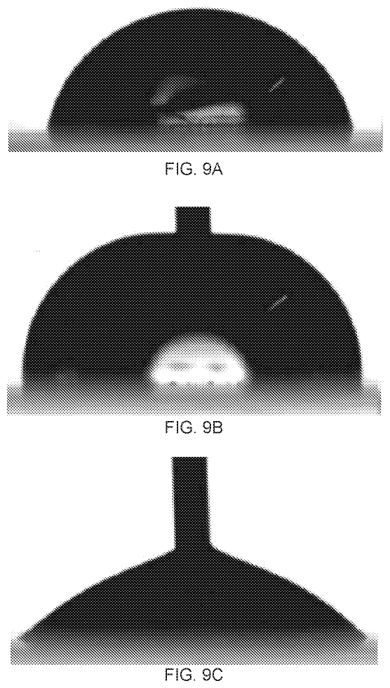

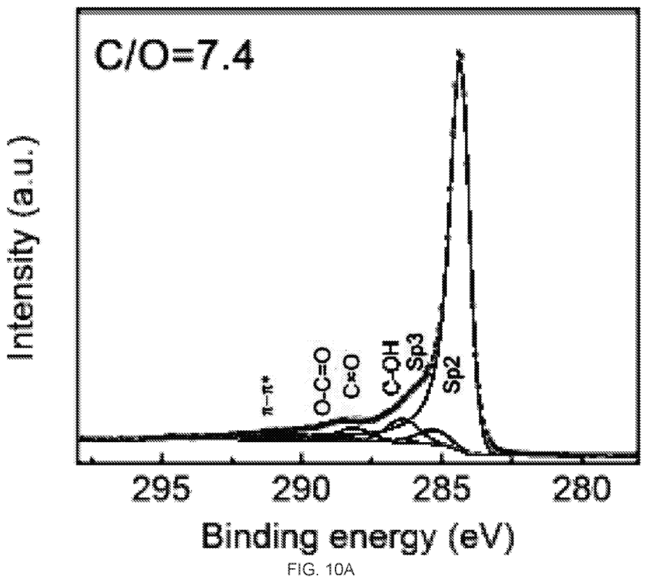

The result showed that the top surface of the partially reduced rGO membrane exhibited static and dynamic wettability similar to the top surface of the fully reduced one (FIGS. 9A-9C). It is worth pointing out that the top surface of the partially reduced rGO membrane had much higher polar residual content (C/O ratio˜3.76) than the bottom surface of the fully reduced one (FIG. 3D), which implies insignificant role of surface chemistry difference in inducing different wetting behaviors and specifically different receding angles in this work. Thus, the above results show that, although there is some difference in the polar residual content of the two surfaces of the rGO members, the difference is unlikely to be responsible to the drastically different wetting behavior on two surfaces of the same rGO membrane.

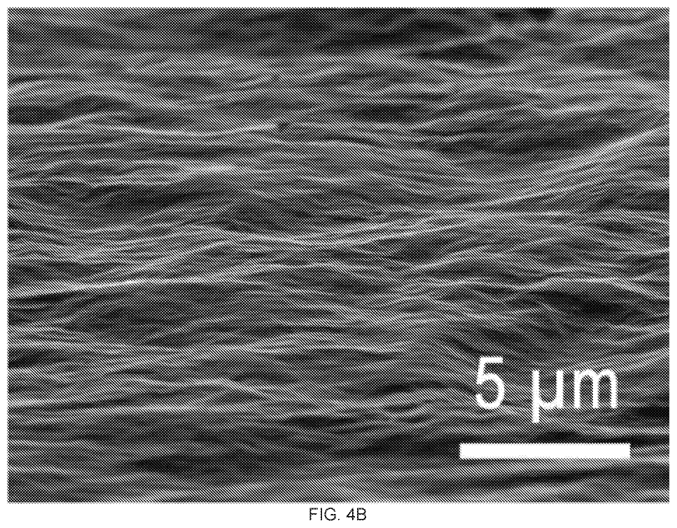

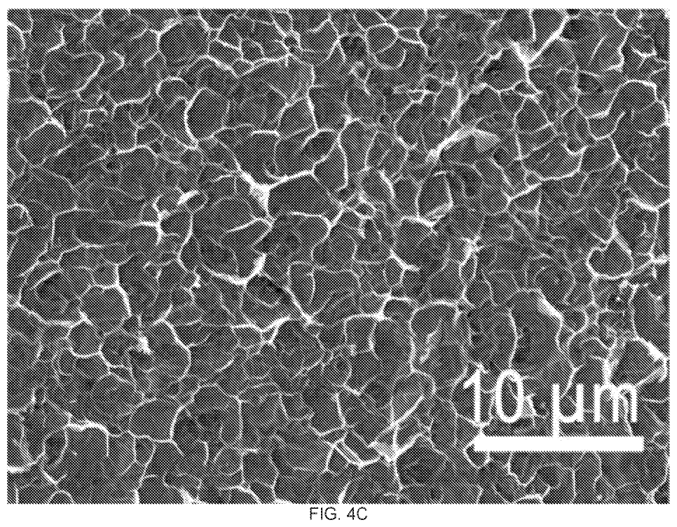

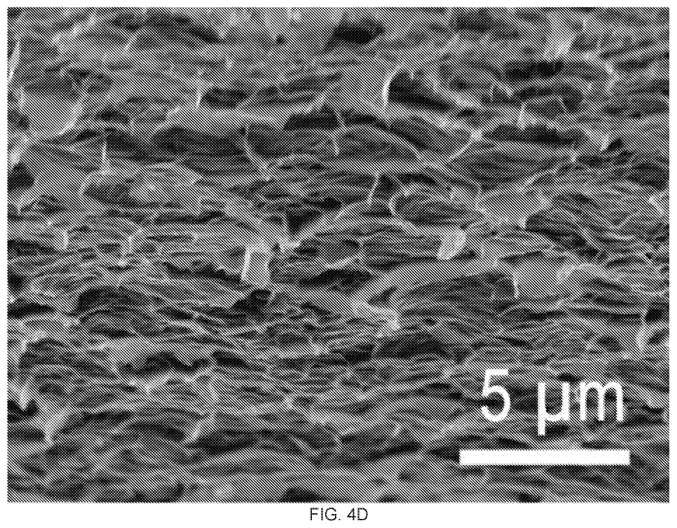

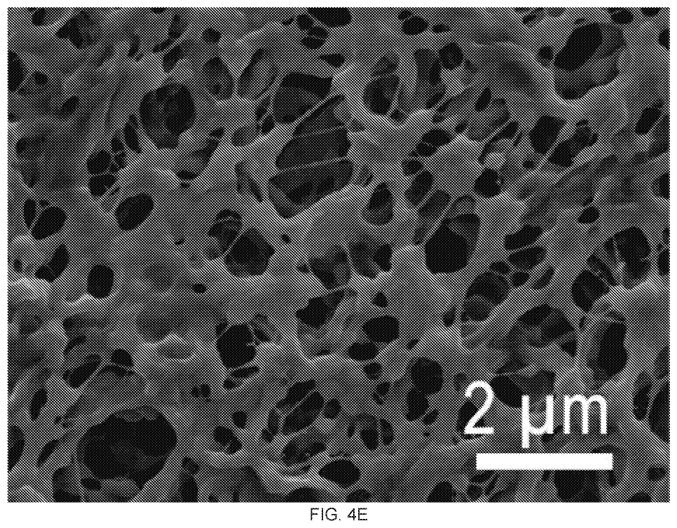

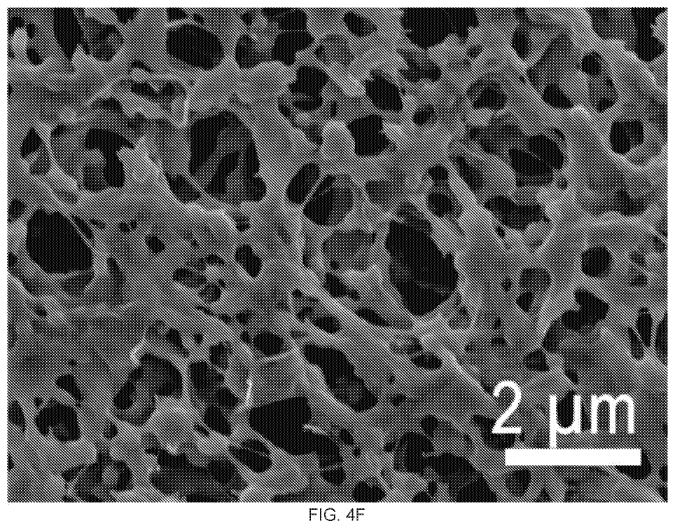

Next, the surface morphology on both surfaces of the rGO membrane was investigated. First, scanning electronic microscopy (SEM) images of the two surfaces of the rGO membrane were recorded and compared, As shown in FIG. 4A and FIG. 4B, the top surface of the rGO membrane showed generally smooth surface. Surprisingly, the bottom surface exhibited drastically different surface morphology, which was highly rough with many petal-like graphene sheets stretching out upright from the membrane surface (FIG. 4C-4D), SEM images were taken of the original PVDF and PVDF filter membrane after removing the overlying rGO membrane and found no rGO residue on the filter surface as well as in the PVDF membrane pores (FIG. 4E-4F), which ruled out the possibility that these rGO surface microstructures were formed during delamination. Furthermore, atomic force microscopy (AFM) analysis was conducted in investigating the surface morphology of the rGO membrane.

In conducting AFM measurements, the areas of 2.5×2.5 μm were scanned for both the surfaces, and root-mean-square roughness, R_{q}, which is considered as a reliable parameter in quantifying surface micro-roughness, was then calculated^{28,38}. The R_{q} values of the top and bottom surfaces of the rGO membrane were calculated to be 31.4 nm and 63.4 nm respectively. Clearly, according to the AFM analysis, the bottom surface assumed a rougher surface structure than the top surface of the same rGO membrane, consistent with the SEM imaging results. The relatively rougher structures on the bottom surface of the rGO membranes may allow the water to penetrate into the grooves and generate great resistance to the motion of the three-phase contact line, leading to lower receding angles^{38,40,41}, It is worth pointing out that the asymmetric morphology was also observed via SEM images of the two surfaces of the GO membrane prepared on PVDF membrane (with a stated pore size of 0.22 μm) without the HI reduction.

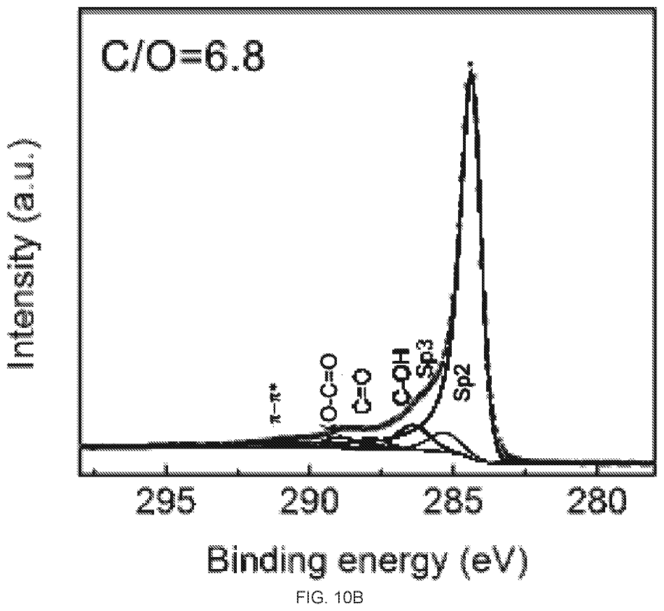

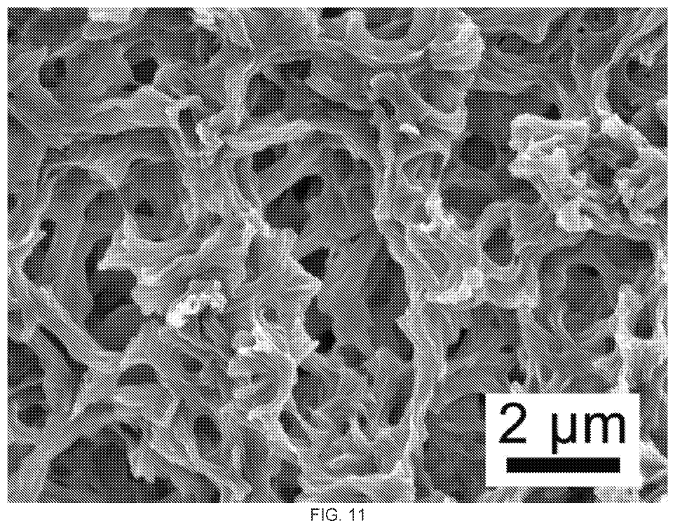

In order to further verify whether surface roughness, or more specifically, the surface petal-like microstructures in this work, is the true cause of the asymmetric wetting behaviors, we turned to polished silicon (Si) wafer, which is considered as a perfectly smooth surface, with an aim at producing rGO membrane with similar roughness and surface morphology on both surfaces. To prepare such a membrane, a GO suspension was dropped on top of the wafer and kept in a 40° C. convective oven for one week to evaporate water, followed by the same HI vapor reduction. A free-standing rGO membrane was ultimately prepared by carefully peeling it off from the Si wafer surface. XPS measurements show that both the top and the bottom surfaces of the rGO membrane exhibited similar chemistry (FIGS. 10A-10B).

The SEM images of the top surface and the bottom surface of the rGO surface prepared on the Si wafer and AFM analysis show that both surfaces of the prepared rGO membrane were similarly smooth, with R_{q} value being 23.6 nm and 20.1 nm on the top and bottom surfaces respectively. As expected, both the top and bottom surfaces of the rGO membrane produced from the Si wafer were smoother compared with those of the rGO membrane prepared on the PVDF membranes. At this point, it came as no surprise that both surfaces of this membrane left behind no water trace upon out of water contact. The advancing and receding angles of the top surface were measured to be 89°±1° and 49°±3°, while these of the bottom surface of the same rGO membrane produced on the Si wafer were 86°±1° and 33°±2°. Thus, with no difference in the surface roughness, the wetting behavior difference becomes insignificant, disclosing that it is the different surface roughness that makes the two surfaces of the same rGO membrane have different wetting behaviors.

Having confirmed the role of surface roughness being responsible for the difference in water wetting behavior of the rGO membranes, efforts were then made in ascertaining whether the rough bottom surface of the rGO membrane could be reproduced if other filter membranes are used in the otherwise same process. In general, from the nature of the filter membrane preparation, filter membranes popularly used in vacuum filtration can be classified into two categories: phase-inversion-based polymeric filter membrane and anodic aluminum oxide (AAO) membrane. Nylon membrane along with the PVDF membrane fall into the first category⁴⁴.

The nylon membrane (with a stated effective pore size of 0.45 um) was employed in the otherwise same vacuum filtration in this study. The results showed that the smooth top surface and rough bottom surface with petal-like microstructures could be well reproduced with the nylon filter membranes. As expected, the bottom surfaces of the rGO membranes prepared on the nylon filter membranes possessed exactly the same water receding angle (i.e., 0°) as the ones prepared on the PVDF membranes.

Next, AAO membrane, fabricated via anodization, was used for the preparation of the rGO membrane by the same process⁴⁴. The AAO membrane has smooth surface and uniform and accurate pore size due to its fabrication process. In this work, an AAO membrane with 0.2 μm pore size was employed as filtration medium to produce rGO membrane. Interestingly, the SEM imaging of the top and bottom surfaces of the rGO membrane prepared on the AAO membrane and AFM analysis revealed that the two surfaces of the so-produced rGO membrane were similarly smooth, with the R_{q} values of the top and bottom surface being 30.3 nm and 37.8 nm respectively. In other words, with the AAO membrane being the filtration medium, the petal-like microstructures were not reproduced on the bottom surface of the rGO membrane. Not surprisingly, the thus-prepared rGO membrane showed no different wetting behavior between the top and bottom surfaces, with the static and dynamic contact angles all measured similar on the two surfaces (Table 1). Especially, the receding angles on the top and bottom surfaces of the thus-made rGO membrane were 41°±3° and 43°±2° respectively.

In comparison, although both the polymeric filter membranes used in the study (i.e., PVDF and nylon) have a stated effective pore size of 0.22 um and 0.45 μm, the surfaces of these filter membranes take on irregular and reticularly interconnected structures and their actual surface pore sizes are quite heterogeneous and diverse, ranging from several tens of nanometer to 2,0 urn for the PVDF membrane (FIG. 4E), and from 0.5 μm to 4.0 μm for the nylon one (FIG. 11). The peripheral dimension of the petal-like microstructures on the bottom surfaces of the rGO membranes were comparable to some of the surface pores of the polymeric filter membrane

These results lead to the conclusion that it is the filter membrane that induces surface petal-like microstructures on the bottom surface of the thus-prepared rGO membrane, provided that the filter membrane surface pore structure is such that it allows the entry of GO sheets into its surface pore space during vacuum filtration. Thus, the surface metal-like microstructures on the bottom surface of the rGO member are indeed physical imprints of the filtration membranes, leading to the asymmetry of the rGO membrane.

To further substantiate that the actual surface pore size of the filter membrane is a factor that controls the filter membrane's imprinting on the bottom surfaces of the rGO membrane and thus the membrane asymmetry, track-etched polycarbonate (PC) membranes were rationally selected. The benefits of using the track-etched membranes are clear: (1) track etching process is capable of generating very uniform and well-controlled pore size; and (2) the pores are regular in shape. The PC membranes with pore sizes of 0.2 μm, 1.0 μm, and 3.0 μm were selected as filtration membranes while keeping the GO mass loading constant at 10 mg during vacuum filtration and compared the surface morphology and wettability behaviors of the two surfaces of the produced rGO membranes.

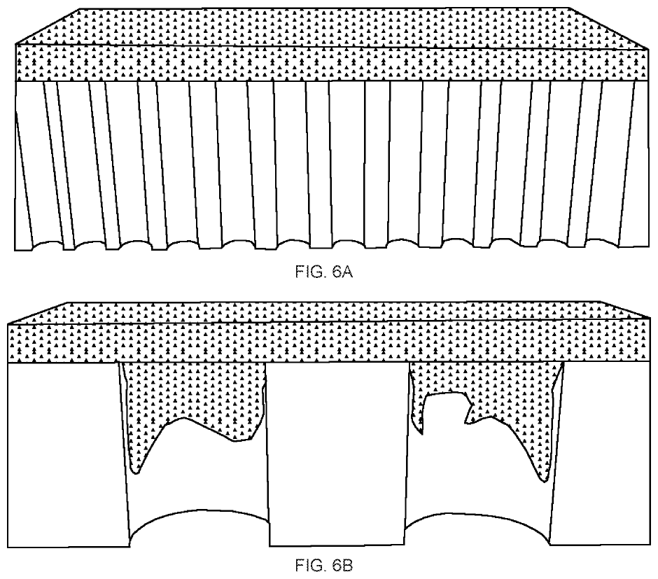

As expected, the SEM images showed smooth morphology on the top surfaces of all rGO samples, which resulted in similarsurface wettability on all top surfaces (Table 2). On the other hand, due to small pore size of the PC membrane, GO sheets, generally with size ranging from 0.5 to 5 μm, are denied entry into the 0.2 μm pores and they end up stacking up on the membrane surface, leading to a petal-like microstructure-free smooth bottom surface of the rGO membrane (FIG. 6A). A smooth surface morphology was observed on the bottom surface of the rGO membrane prepared on the PC membrane with 0.2 μm pore size.

However, when the PC membrane pore size was 1.0 μm, irregular petal-like microstructures were visible on the bottom surface of the rGO membrane. Interestingly, when the PC filter membrane pore size was 3.0 μm, round-shaped petal microstructures were clearly observed on the bottom surfaces of the rGO membranes, and the sizes of the petal-like microstructures perfectly matched with the pore size of the corresponding PC filter membrane. The tilted-view SEM images of the bottom surfaces indicate that the height of the petal-like microstructures ranged from several ten nanometers to one micrometer. Such large surface pore size of these filter membrane allows the GO nanosheets with similar lateral dimension to partially penetrate, thus forming the petal-like structure (FIG. 6B).

Different from the top surfaces of the rGO membranes, a clear and gradual transition with increasing PC filter membrane pore size was observed in the receding angles on the bottom surfaces of the rGO (Table 2). More specifically, a clear transition from a symmetry to asymmetry in the wetting behaviors of the both surfaces of the rGO membranes was obtained as the pore size of the PC filter membranes increased from 0.2 to 3.0 μm, with the receding angles on the bottom surface reduced to 0° at 3.0 μm PC filter membrane pore size.

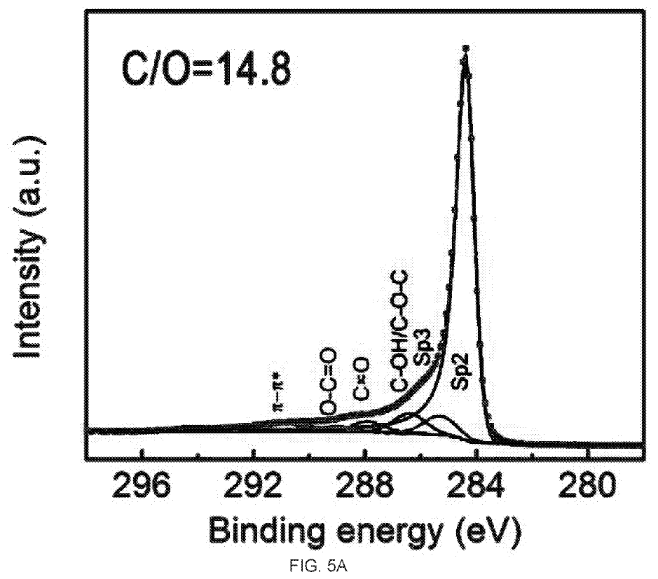

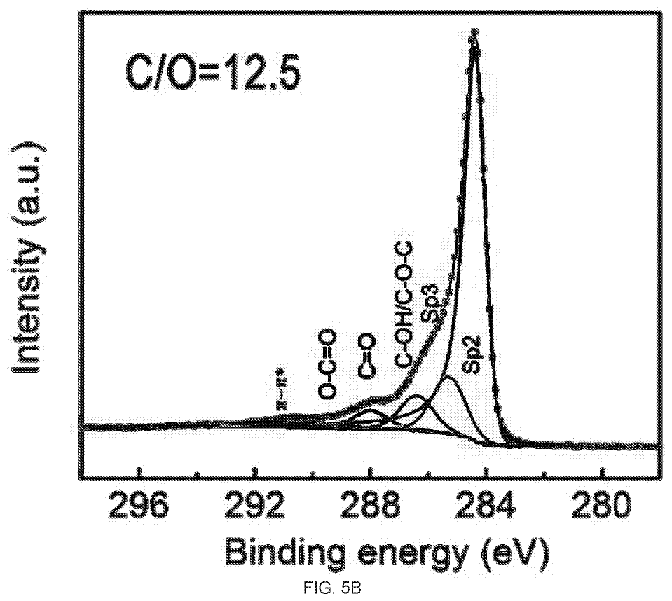

XPS analysis showed no significant difference in surface chemistry on the two surfaces (FIG. 5A and FIG. 5B). Thus, the results from the PC membrane experiments clearly demonstrate: (1) the pore size of filtration membrane controls the surface roughness, in the form of surface petal-like microstructures, on the bottom surface of the so-produced rGO membrane; (2) with suitable pore size, surface petal-like microstructures are resulted in on the bottom surface of rGO membrane, which mimics the surface pore structures and thus is the physical imprint of the filtration membrane; and (3) the surface petal-like microstructures, once present, induces strong interaction of surface to water, leading to the decreased water receding angle.

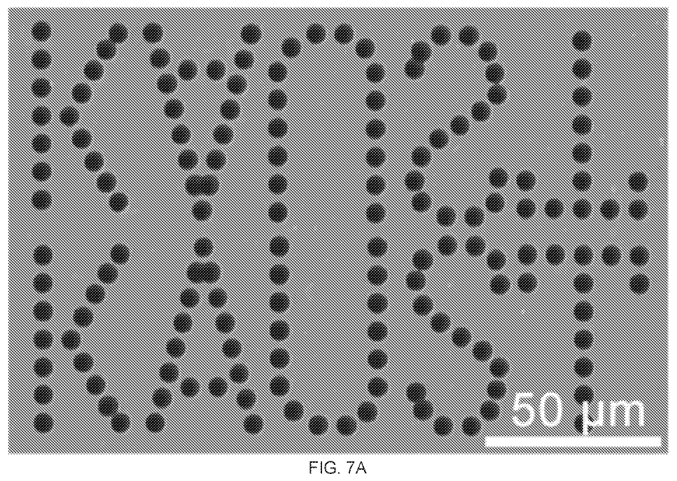

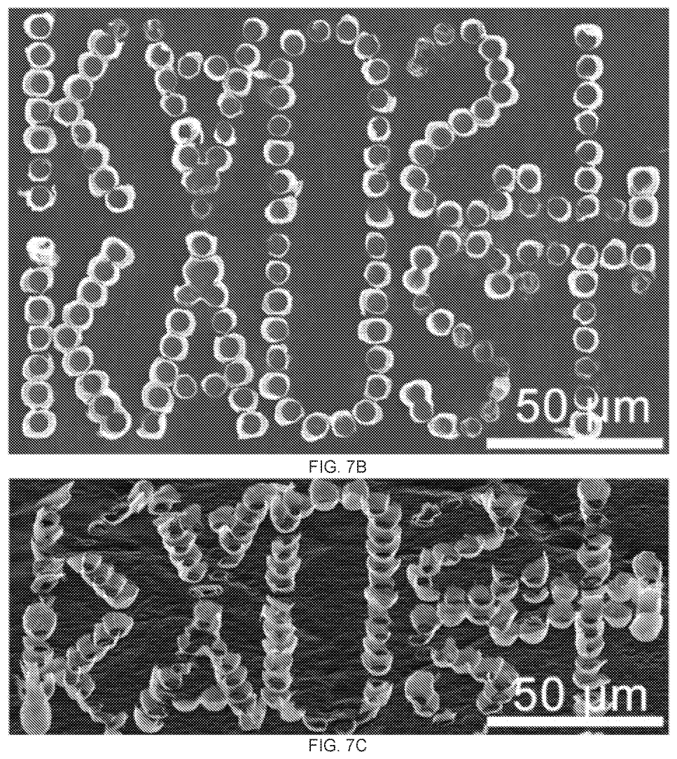

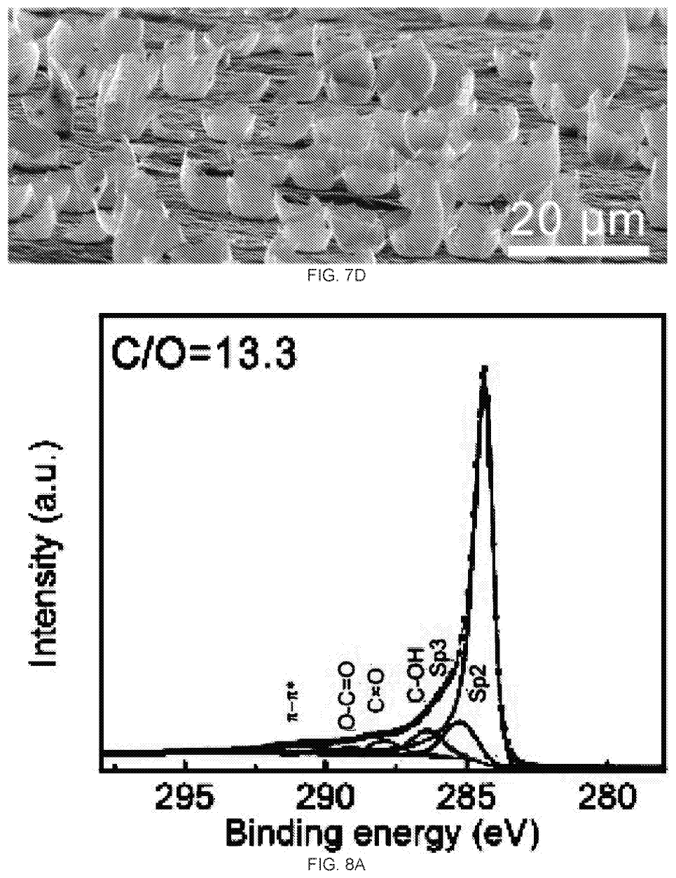

The newfound imprinting mechanism inspired us to deliberately and selectively engineer only the bottom surface of thin rGO membranes. To this end, a silicon wafer with a pre-designed pattern (i.e., KAUST in capital letters) of through-micropore array with pore size at 5.0 μm (FIG. 7A) by lithography was created and employed as a filter membrane in the vacuum filtration of GO suspension. FIG. 7B and FIG. 7C present the SEM images of the bottom surface of the thus-produced rGO membrane, clearly showing that the same pattern was faithfully imprinted on the rGO membrane bottom surface, and the pattern was made of discrete petal-like microstructures with the diameteraround 5.0 um (FIG. 7D).

### Methods

Materials

The graphite powder, sodium nitrate, potassium permanganate, hydrochloric acid (HCl), and hydriodic acid (HI) were purchased from Sigma Aldrich™ (St. Louis, MI, USA). De-ionized water produced by Milli Q™ filtration system was used in all experiment. The hydrophilic PVDF membrane filter with a stated pore size of 0.22 μm and the hydrophilic Nylon membrane filter with a stated pore size of 0.45 μm were purchased from Millipore™. The AAO membrane filter with a pore size 0.20 μm and the filter paper were purchased from Whatman™. The 0.2 μm pore size PC membrane was purchased from Millipore™ and the 1 μm and 3μm PC membranes were purchased from Whatman™.

Preparation of GO and rGO Membranes

GO nanosheets were prepared from graphite by a modified Hummers' method^{31,45}. In order to fabricate GO membranes with difference thickness, a series of GO suspensions (˜50 mL) with different GO mass ranging from 1 mg up to 10 mg were prepared by diluting the GO suspension prepared previously, then the diluted GO suspension was filtrated under vacuum by the membrane filters (e.g., PVDF, nylon, PC, AAO). Upon completion of the filtration, the intact GO/membrane filter complex was dried under room temperature overnight before the reduction. The reduction of GO to rGO was conducted in a sealed container where a glass bottle containing 2 ml of HI solution was placed uncapped to allow the HI vapor to evaporate. The container was sealed and kept in an oven at 90° C. for 2 h. A freestanding rGO membrane was ultimately obtained by peeling the reduced GO from the membrane filter.

The Si wafer with patterned micropores used for the imprinting experiment was prepared using standard lithography etching by deep reactive ion etching (DRIE)^{46,47}. The pre-designed pattern was ‘KAUST’ was made of properly spaced micropores with a uniform diameter of ˜5.0 μm. The Si wafer was then used in the vacuum-assisted GO suspension filtration using similar procedure. The mass of the GO in suspension was 10 mg and the obtained GO membrane was then reduced by HI.

Characterization

All contact angles data were measured on a dynamic contact analyzer OCA35 from DataPhysics. The droplet volume applied for static CA is 4 μl. For all advancing CA and receding CA, the volume of the droplet at the starting point is 4 μl and the dispensing and withdrawing speed is 0.5 μl/s. The surface morphology of the substrate was examined using scanning electron microscopy (FEI Quanta 600). Surface roughness analysis was carried out on atomic force microscopy (Agilent 5400 SPM). X-ray photoelectron spectroscopy (XPS) studies were carried out in a Kratos Axis Ultra DL© spectrometer equipped with a monochromatic Al Ka X-ray source (hv=1486,6 eV) operating at 150 W, a multi-channel plate and delay line detector under a vacuum of ˜10⁻⁹ mbar.

It should be emphasized that the above-described embodiments are merely examples of possible implementations, Many variations and modifications may be made to the above-described embodiments without departing from the principles of the present disclosure. All such modifications and variations are intended to be included herein within the scope of this disclosure and protected by the following claims.

### REFERENCE

1. Geim, A, K. & Novoselov, K. S. The rise of graphene. Nat. Mater, 6, 183-191 (2007).
2. Novoselov, K. S. et al. Electric field effect in atomically thin carbon films. Science 306, 666-669 (2004).
3. Dreyer, D. R., Park, S., Bielawski, C. W. & Ruoff, R. S. The chemistry of graphene oxide. Chem. Soc, Rev. 39, 228-240 (2010),
4. Li, D. & Kaner, R. B. Graphene-based materials. Nat. Nanotechnol. 3, 101 (2008),
5. Zhu, Y. et al. Graphene and graphene oxide: synthesis, properties, and applications. Adv. Mater. 22, 3906-3924 (2010),
6. Guo, S. & Dong, S. Graphene nanosheet: synthesis, molecular engineering, thin film, hybrids, and energy and analytical applications. Chem. Soc. Rev. 40, 2644-2672 (2011).
7. Becerril, H. A. et al. Evaluation of solution-processed reduced graphene oxide films as transparent conductors. ACS Nano 2, 463-470 (2008).
8. Chen, Y., Chen, L., Bai, H. & Li, L. Graphene oxide—chitosan composite hydrogels as broad-spectrum adsorbents for water purification. J. Mater. Chem. A 1, 1992-2001 (2013).
9. Cohen-Tanugi, D, & Grossman, J. C. Water desalination across nanoporous graphene. Nano Lett. 12, 3602-3608 (2012).
10. Dua, V. et al. All-organic vapor sensor using inkjet-printed reduced graphene oxide. Angew. Chem. Int, Ed. 49, 2154-2157 (2010),
11. Pei, S., Zhao, J., Du, J., Ren, W. & Cheng, H.-M. Direct reduction of graphene oxide films into highly conductive and flexible graphene films by hydrohalic acids. Carbon 48, 4466-4474 (2010).
12, Wei, Z. et al, Nanoscale tunable reduction of graphene oxide for graphene electronics. Science 328, 1373-1376 (2010).
13. Zou, J. & Kim, F. Diffusion driven layer-by-layer assembly of graphene oxide nanosheets into porous three-dimensional microstructures. Nat. Commun. 5 (2014).
14. Li, D., Mueller, M. B., Gilje, S., Kaner, R. B. & Wallace, G. G. Processable aqueous dispersions of graphene nanosheets. Nat. Nanotechnol. 3, 101-105 (2008).
15. Dikin, D. A. et al. Preparation and characterization of graphene oxide paper, Nature 448, 457-460 (2007).
16, Eda, G. Fanchini, G. & Chhowalla, M. Large-area ultrathin films of reduced graphene oxide as a transparent and flexible electronic material. Nature Nanotechnol. 3, 270-274 (2008).
17. Liu, H., Wang, H. & Zhang, X. Facile fabrication of freestanding ultrathin reduced graphene oxide membranes for water purification. Adv. Mater, 27, 249-254 (2015).
18. Xu, Y., Bai, H., Lu, G., Li, C. & Shi, G. Flexible graphene films via the filtration of water-soluble noncovalent functionalized graphene sheets. J. Am. Chem. Soc. 130, 5856-5857 (2008).
19. Coleman, J. N. et al. Two-dimensional nanosheets produced by liquid exfoliation of layered materials. Science 331, 568-571 (2011).
20. Kong, B.-S., Geng, J. & Jung, H.-T. Layer-by-layer assembly of graphene and gold nanoparticles by vacuum filtration and spontaneous reduction of gold ions. Chem. Commun., 2174-2176 (2009).
21. Wang, D. et al, Ternary self-assembly of ordered metal oxide-graphene nanocomposites for electrochemical energy storage. ACS Nano 4, 1587-1595 (2010).
22. Choi, B. G., Yang, M., Hong, W. H., Choi, J. W. & Huh, Y. S. 3D macroporous graphene frameworks for supercapacitors with high energy and power densities. ACS Nano 6, 4020-4028 (2012).
23. Xu, C., Cui, A., Xu, Y. & Fu, X. Graphene oxide-TiO 2 composite filtration membranes and their potential application for water purification. Carbon 62, 465-471 (2013).
24. Han, Y., Xu, Z. & Gao, C, Ultrathin graphene nanofiltration membrane for water purification. Adv. Func. Mater, 23, 3693-3700 (2013).
25. Hu, M. & Mi, B. Enabling graphene oxide nanosheets as water separation membranes. Environ. Sci. Technol. 47, 3715-3723 (2013).
26. Wu, C. et al. Two-dimensional vanadyl phosphate ultrathin nanosheets for high energy density and flexible pseudocapacitors. Nat. Commun. 4 (2013).
27. Stankovich, S. et al. Synthesis of graphene-based nanosheets via chemical reduction of exfoliated graphite oxide. Carbon 45, 1558-1565 (2007).
28. Huang, Y. et al. Ultrafiltration Membranes with Structure-Optimized Graphene-Oxide Coatings for Antifouling Oil/Water Separation. Adv. Mater. Interf. 2 (2015).
29. Nair, R., Wu, H., Jayaram, P., Grigorieva, I. & Geim, A. Unimpeded permeation of water through helium-leak---tight graphene-based membranes. Science 335, 442-444 (2012).
30. Yeh, C.-N., Raidongia, K., Shad, J., Yang, O.-H. & Huang, J. On the origin of the stability of graphene oxide membranes in water. Nat. Chem. 7, 166-170 (2015).
31. Zhang, L., Chen, G., Hedhili, M. N Zhang, H. & Wang, P. Three-dimensional assemblies of graphene prepared by a novel chemical reduction-induced self-assembly method. Nanoscale 4, 7038-7045 (2012).
32. Zhang, J. et al. Reduction of graphene oxide via L-ascorbic acid. Chem. Commun, 46, 1112-1114 (2010).
33. Moon, I. K., Lee, J., Ruoff, R. S. & Lee, H. Reduced graphene oxide by chemical graphitization. Nat. Commun. 1, 73 (2010).
34. Raj, R., Maroo, S. C. & Wang, E. N. Wettability of graphene. Nano Lett. 13, 1509-1515 (2013).
35. Cheng, D. F., Urata, C., Yagihashi, M. & Hozumi, A. A statically oleophilic but dynamically oleophobic smooth nonperfluorinated surface. Angew. Chem. Int, Ed. 124, 3010-3013 (2012).
36. Krumpfer, J. W. & McCarthy, T. J. Contact angle hysteresis: a different view and a trivial recipe for low hysteresis hydrophobic surfaces. Farad. Discuss. 146, 103-111 (2010).
37. Wong, T.-S. et al. Bioinspired self-repairing slippery surfaces with pressure-stable omniphobicity. Nature 477, 443-447 (2011).
38. Pittoni, P. G., Lin, C.-H., Yu, T.-S. & Lin, S.-Y. On the Uniqueness of the Receding Contact Angle: Effects of Substrate Roughness and Humidity on Evaporation of Water Drops. Langmuir 30, 9346-9354 (2014).
39. Sun, T., Feng, L., Gao, X. & Jiang, L. Bioinspired surfaces with special wettability, Acc. Chem. Res. 38, 644-652 (2005).
40. Liu, K., Tian, Y. & Jiang, L. Bio-inspired superoleophobic and smart materials: design, fabrication, and application, Prog. Mater. Sci. 58, 503-564 (2013).
41. Kota, A. K., Choi, W. & Tuteja, A, Superomniphobic surfaces: Design and durability. MRS bull. 38, 383-390 (2013).
42. Kia, X. et al. Reduced-graphene oxide/molybdenum oxide/polyaniline ternary composite for high energy density supercapacitors: Synthesis and properties. J. Mater. Chem. 22, 8314-8320 (2012).
43. Haubner, K. et al. The route to functional graphene oxide. ChemPhysChem 11, 2131-2139 (2010).
44, Drioli, E. & Giorno, L. Comprehensive membrane science and engineering. Vol. 1 (Newnes, 2010).
45. Hummers Jr, W. S, & Offeman, R. E, Preparation of graphitic oxide. J. Am, Chem. Soc. 80, 1339-1339 (1958).
46. Warkiani, M. E. et al. Isoporous micro/Nanoengineered membranes. ACS Nano 7, 1882-1904 (2013).
47. Wu, J, et al. Patterning cell using Si-stencil for high-throughput assay. RSC Advances 1, 746-750 (2011).

TABLE 1

| | | Top surface of the rGO membranes | | | | Bottom surface of the rGO membrane | | | |
|---|---|---|---|---|---|---|---|---|---|
| | | Static | Advancing | Receding | | Static | Advancing | Receding | |
| | Actual | contact | contact | contact | | contact | contact | contact | |
| Substrate | pore size | angle | angle | angle | Rq | angle | angle | angle | Rq |
| PVDF | 0.5~4 μm | 76° ± 5° | 94° ± 1° | 45° | 31.4 nm | 75° ± 1° | 92° ± 2° | 0° | 63.4 nm |
| AAO | 0.2 μm | 77° ± 1° | 82° ± 2° | 41° ± 3° | 30.3 nm | 73° ± 1° | 85° ± 1° | 43° ± 2° | 37.8 nm |
| Si wafer | 0 | 72° ± 2° | 89° ± 1° | 49° ± 3° | 23.6 nm | 71° ± 1° | 86° ± 1° | 33° ± 2° | 20.1 nm |

TABLE 2

| | Top surface of rGO membrane | | | Bottom surface of rGO membrane | | |
|---|---|---|---|---|---|---|
| | Static contact | Advancing | Receding | Static contact | Advancing | Receding |
| Substrate | angle | contact angle | contact angle | angle | contact angle | contact angle |
| PC (0.2 μm) | 71° ± 1° | 89° | 44° ± 3° | 76° ± 4° | 91° ± 1° | 56° ± 1° |
| PC (1 μm) | 74° ± 3° | 90° ± 1° | 43° ± 2° | 71° ± 2° | 90° ± 1° | 32° ± 2° |
| PC (3 μm) | 72° ± 4° | 91° ± 1° | 47° ± 4° | 65° ± 3° | 84° ± 3° | 0° |

1. A method of growing a thin film of a nanoscale material, the method comprising:
applying a suspension comprising the nanoscale material and a suitable solvent onto a porous substrate, and
removing the solvent to form the thin film on a surface of the substrate, wherein the porous substrate has a pore size that is about the size of the nanoscale material.

2. The method of claim 1 , wherein the porous substrate comprises a plurality of pores forming a pattern on the surface of the substrate and the method comprises forming the thin film having the pattern on a surface of the thin film.

3. The method of claim 2, wherein the pattern has microscale feature dimensions.

4. The method of claim 2, wherein the surface of the thin film is the top surface, bottom surface, or both the top surface and bottom surface.

5. The method of claim 1, wherein the nanoscale material is one or more of graphene, graphene oxide, reduced graphene oxide, molybdenum disulfide (MOS₂), hexagonal boron nitride (hBN), tungsten diselenide (WSe₂), molybdenum trioxide, montmorillonite, and lapnotie.

6. The method of claim 1, wherein the porous substrate is one or more of a porous organic membrane, a porous inorganic membrane, a silicon stencil membrane, and other membranes having a pore size on the order of 10 nm to 100 μm.

7. The method of claim 1, further comprising applying a pressure difference to accelerate the removal of the solvents.

8. The method of claim 7, wherein the pressure difference is provided by applying vacuum on the bottom surface or by applying additional pressure on the top surface.

9. The method of claim 1, further comprising chemically reducing the nanoscale material.

10. The method of claim 1, wherein the nanoscale material has a largest dimension of 10 nm to 100 μm.

11. The method of claim 1, wherein the porous substrate has a pore size of 10 nm to 100 μm

12. The method of claim 1, wherein the thin film has a thickness of 0.01 μm to 5 μm.

13. A thin film of a nanoscale material made according to the method of any one of claims 1-14.

14. The method of claim 9, wherein chemically reducing includes exposing the thin film to a vapor containing a reducing agent.

15. The method of claim 14, wherein the reducing agent is one or more of hydriodic acid, hydrobromic acid, hydrochloric acid, and hydrofluoric acid.

16. The method of claim 9, wherein the nanoscale material is graphene and the nanoscale material is chemically reduced to reduced graphene oxide.

17. The method of claim 1, wherein the porous substrate is one or more of a porous PVDF membrane and porous Si membrane.

18. The method of claim 4, wherein the top surface and bottom surface each have different chemical and/or physical properties.

18. The method of claim 4, wherein the top surface and bottom surface each have a different wettability.

19. The method of claim 18, wherein the top surface of the thin film has a wettability that is about 2 to 40 times the wettability of the bottom surface of the thin film measured under the same conditions.

20. The method of claim 7, wherein the applying pressure is performed at a pressure of about 500 Torr or less.
